(19) United States
(12) Patent Application Publication
(10) Pub. No.: US 2006/0183547 A1
(43) Pub. Date: Aug. 17, 2006

(54) Fantasy sports television programming systems and methods

(76) Inventor: Mace McMonigle, Corona del Mar, CA (US)

Correspondence Address: Law Offices of K. W. Float, Suite 2-F, #356, 2095 Hwy. 211 NW, Braselton, GA, 30517, US

(21) Appl. No.: 11/057,310

(22) Filed: Feb. 11, 2005

(51) Int. Cl. G06F 17/00

(52) U.S. Cl. 463/40

(57) ABSTRACT

Systems and methods are disclosed that include display systems located at player sites, a server system for generating a television channel comprising real-time live off-shore odds, fantasy betting sports games, standard fantasy sports games, and sports prognosticator predictions, and a communication link for transmitting the television channel to the display systems. The television channel may comprise standard and enhanced fantasy sports games and standard and enhanced fantasy betting sports games with real-time live off-shore odds derived from the one or more off-shore sports books, and sports predictions from sports prognosticators using real-time live off-shore odds from one or more off-shore sports books. Exemplary communication links include cable and satellite providers, telephones, other wireless and wired devices and the Internet. Content may be transmitted by way of cable and satellite providers, telephones, other wired and wireless devices and the Internet. Exemplary display systems include digital non-interactive television systems, digital interactive television systems and web-enabled computer devices. Exemplary programming formats include a linear video channel, a linear interactive television (iTV) channel, an Internet protocol television (IP-TV) channel, and a website channel. The present invention permits interactive fantasy betting on and playing of fantasy betting sports games and fantasy sports games using real-time off-shore betting odds displayed on a television or computer device. The present invention delivers real-time off-shore odds, fantasy betting sports games, fantasy sports games, sports prognosticator predictions, fantasy betting casino games and fantasy casino games for display on television systems and computer devices that implement interactive TV, IP-TV and non-interactive TV.

### TECHNICAL FIELD

The present invention relates generally to digital television services, and more particularly, to systems and methods for presenting fantasy betting sports games, fantasy sports games, sports prognosticator predictions and live off-shore odds to players of both fantasy betting and other standard fantasy sports games.

### BACKGROUND

In order to fully understand the present invention, fantasy games are defined as all fantasy games that in any manner are based upon, pertain to, or are associated with actual sporting events and actual sports figures. Fantasy games may include, but are not limited to (1) “standard fantasy betting sports games”which are currently available, (2) “enhanced fantasy betting sports games” in accordance with the present invention which are based upon live off-shore odds, (3) “standard fantasy sports games” which are those fantasy games wherein users build fantasy teams and leagues by drafting or trading sports figures from real teams and collect points based on how those sports figures play in the real world. Standard fantasy sports games do not use or rely on off-shore odds, and (4) fantasy sports games in accordance with the present invention referred to as “enhanced fantasy sports games” which include additional elements not in other sports games, examples of which are discussed below.

Prognosticators make predictions based on casino odds and “sports prognosticators” in accordance with the present invention make predictions based on off-shore odds. A “player” is a person who plays any of the fantasy games and a “sports figure” is an actual sports personality who plays in real-world games.

Sports and activities surrounding them, including standard fantasy sports games and fantasy betting sports games, have become one of the most important entertainment choices for American men. Sports are well known to be one of the most targeted and lucrative options for motivating rapid audience growth for cable, satellite and broadcast delivery and advertisers worldwide. However, heretofore, all sports programming on television, within certain parameters, is very similar, and the only true differentiating factors are the types of sports, the teams and the players.

A number of enterprises have been proposed or developed relating to interactive television or Internet programming. For example, AOL, CBS Sportsline, and ESPN provide standard fantasy sports gaming as part of their Internet service on websites. It appears that Best Buy has decided to introduce a free standard fantasy football game on its website, and will offer plasma screens as prizes. Also, Fox intends to launch a standard fantasy sports channel on DirecTV in 2005.

Internet websites, newspapers, magazines and cell phones carry sports information. However, none of them have the ease or immediacy of a television channel. A channel in linear digital form can carry off-shore odds, fantasy statistics and related programming and when such channel is interactive, deliver standard and enhanced fantasy sports games and standard and enhanced fantasy betting sports games. It may be played silently in the background throughout the day or clicked to at a moment's notice.

There are a few websites that offer fantasy betting sports contests such as Wagerline.com and Fanball.com. The Fanball.com site is a fantasy sports site that has a few simulated wagering contests as an adjunct to its standard fantasy sports games. The Wagerline.com site provides standard fantasy league betting contests. None of the websites is tied to an interactive television channel, or any television channel for that manner.

A number of US patents relate to standard fantasy sports games, but do not cover any fantasy betting sports games. These patents include U.S. Pat. No. 4,918,603, U.S. Pat. No. 5,018,736, U.S. Pat. No. 5,263,723, U.S. Pat. No. 5,846,132, U.S. Pat. No. 5,860,862, U.S. Pat. No. 5,971,854, U.S. Pat. No. 6,135,881, U.S. Pat. No. 6,193,610, U.S. Pat. No. 6,371,855, U.S. Pat. No. 6,669,565, and U.S. Pat. No. 6,688,978.

However, there are currently no cable or other television channels that provide for interactive fantasy betting on sports games and interactive playing of fantasy sports games, or that display real-time, live off-shore betting odds on an interactive television device. Also, there is no television device whose programming is integrally associated with a computer device for use by individuals to fantasy bet on sports games using off-shore odds and play standard or enhanced fantasy sports games on the computer device using information from the television device. In addition, there are currently no cable or other television channels that provide a combination of live off-shore odds, fantasy betting and fantasy sports games that are displayed on television or simulate television resulting from the use of computer devices, or specifically with interactive TV, IP-TV or non-interactive TV.

### SUMMARY OF THE INVENTION

Embodiments of the present invention provide for enhanced fantasy sports and enhanced fantasy betting television systems and methods that comprise display systems located at consumer or player sites, a server system for generating a television channel (The Scoreline Channel™, “SLC”) comprising standard and enhanced fantasy sports games and standard and enhanced fantasy betting sports games with real-time live odds derived from multiple off-shore sports books used for information purposes, playing in fantasy games and for any other purpose whatsoever and a communication link coupled between the server system and the display systems for transmitting the television channel including the real-time live odds, standard and enhanced fantasy betting sports games and standard and enhanced fantasy sports games to the display systems. Exemplary communication links include cable and satellite providers and the Internet. Exemplary display systems include digital television systems and web-enabled computer devices, such as personal computers, for example. Exemplary programming formats include a linear video channel, an interactive television (iTV) channel, an Internet protocol television (IP-TV) channel, and a website channel.

Various embodiments of the present invention are provided that employ different types of content delivery systems and display systems. For example, in one embodiment, a linear television channel is produced that includes only real-time live odds with associated standard and enhanced fantasy betting sports games and standard and enhanced fantasy sports games played interactively over the Internet. The linear television channel is transmitted by way of cable and satellite providers to digital television systems. The interactive television (iTV) channel is transmitted by way of cable and satellite providers to interactive television systems. The content of the interactive television channel may include, but is not limited to, live off-shore odds, sports prognosticator predictions, standard and enhanced fantasy sports games, standard and enhanced fantasy betting sports games and interactive commerce. The Internet protocol television (IP-TV) channel is transmitted by way of the Internet to digital television systems incorporating IP-TV set-top boxes. Content there may include, but is not limited to, live off-shore odds, standard and enhanced fantasy betting sports games, standard and enhanced fantasy sports games, sports prognosticator predictions and interactive commerce. The website channel may be transmitted by way of the Internet to web-enabled computer devices that are logged onto the Scoreline Channel website. Content there may include, but is not limited to, the elements included in iTV.

In certain embodiments, the present invention provides for a television system or channel that permits interactive fantasy betting on simulated sports games and standard and enhanced fantasy sports games using real-time off-shore betting odds displayed on a television or computer device. It also permits playing of standard and enhanced fantasy sports games. It also permits predictions by sports prognosticators using offshore odds. Embodiments of the present invention provide for a television system or channel that delivers real-time off-shore odds, sports prognosticator predictions, standard and enhanced fantasy betting sports games and standard and enhanced fantasy sports games for display on television systems and computer devices that implement interactive TV and IP-TV. Non-interactive television systems provide only off-shore odds, fantasy and regular sports statistics and normal video content, and its interactive component is the interactive website.

Embodiments of the present invention may display a streaming Chiron (“Fantastat™”) that displays detailed fantasy sports statistics on a 24 hour basis, including player statistics, injury reports and team updates, for example. Embodiments of the present invention may display an “SLC Average” odds line, which is an indexed average of all the offshore betting odds on the screen of the television or other device. Embodiments of the present invention may display information and predictions provided by sports prognosticators and information provided by league experts.

The present invention provides immediate access to live off-shore odds and other sports and fantasy sports related information relating to the most popular sports such as professional and college football and basketball, hockey, major league baseball, golf, NASCAR, arena football, boxing, soccer, rugby, cricket, tennis, auto racing and grand prix racing, 24 hours a day, whenever sports fans and fantasy players want them. No television channel in the market does or has ever done this.

In addition, the present invention provides access to fantasy casino games including poker, solitaire, blackjack, bridge, canasta, cribbage, deuces wild, double down, euchre, gin, hearts, spades, backgammon, chess, checkers, mahjong, and bingo. No television channel in the market does or has ever done this.

The present invention implements a format of league play for some of the enhanced fantasy betting sports games and all of the standard and enhanced fantasy sports games that is familiar to fantasy sports players. In the enhanced fantasy betting sports games this is combined with the excitement of using real-time live off-shore odds, which has not been done before. In most standard fantasy wagering contest sites, gamers simply play one-offs against the entire population of the site. The present fantasy betting invention permits interactive competition between many players using real-time off-shore odds, making the gaming experience more realistic but without providing any negative financial consequences.

### BRIEF DESCRIPTION OF THE DRAWINGS

The various features and advantages of embodiments of the present invention may be more readily understood with reference to the following detailed description taken in conjunction with the accompanying drawings, wherein like reference numerals designate like structural elements, and in which:

FIG. 1 illustrates exemplary embodiments of systems in accordance with the principles of the present invention;

FIG. 2 illustrates details of the systems shown in FIG. 1;

FIG. 3 illustrates an exemplary enhanced fantasy wagering process flow diagram;

FIG. 4 illustrates an exemplary fantasy use case model;

FIG. 5 illustrates an exemplary screen display of a computer device presented to a user when initially viewing the channel;

FIG. 6 illustrates an exemplary screen display of a computer device presented to a player that is not logged in;

FIG. 7 illustrates an exemplary screen display of a computer device presented to a player that is logged in;

FIG. 8 illustrates an exemplary screen display showing complete live off-shore odds;

FIG. 9 illustrates an exemplary screen display showing half-time off-shore odds;

FIG. 10 illustrates an exemplary screen display showing match-up statistics; and

FIG. 11 is a flow diagram illustrating exemplary embodiments of methods in accordance with the principles of the present invention.

### DETAILED DESCRIPTION

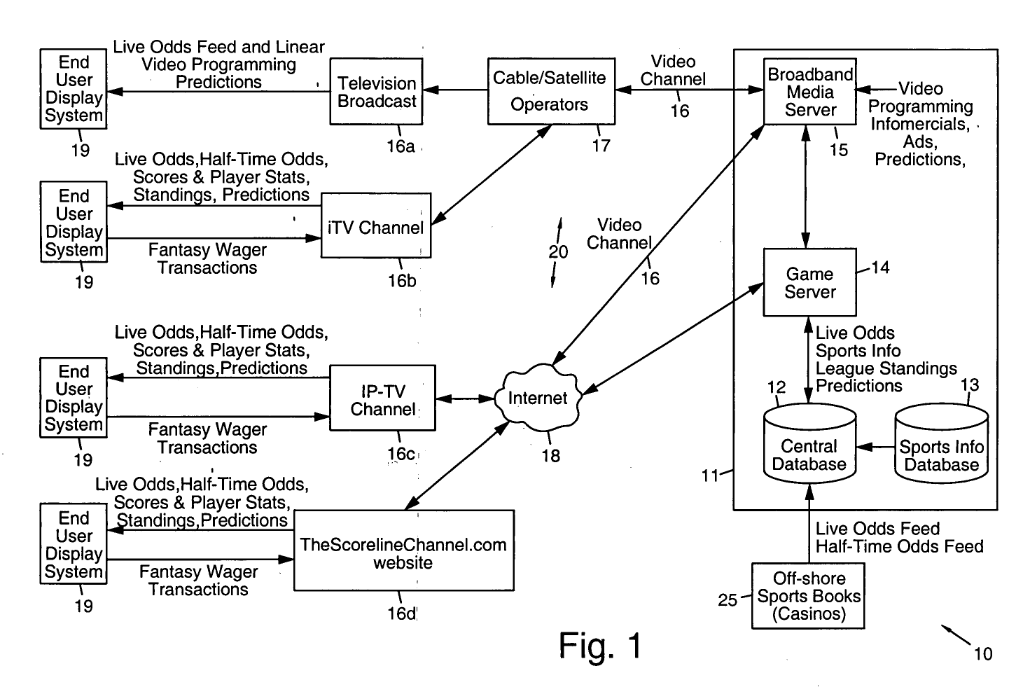

Referring to the drawing figures, FIG. 1 illustrates exemplary embodiments of systems 10 in accordance with the principles of the present invention. All systems 10 implement a standard and enhanced fantasy betting sports games and standard and enhanced fantasy sports gaming television channel 10 (The Scoreline Channel™, “SLC”) for distribution to consumers or end users, and in particular fantasy sports players and fantasy sports bettors All systems 10 deliver real-time live odds (off-shore odds) derived from multiple off-shore sports books 25, casinos 25, or odds-makers 25, which has not heretofore been provided by any sports channel or fantasy sports channel.

In general, the system 10 comprises a display system 19 located at a consumer or game player site. The display system 19 may be a television system, 19 an interactive television system 19, an Internet protocol television (IP-TV) system 19, a web-enabled computer device 19, such as a personal computer, a wireless device 19, or any other display system 19 capable of receiving and displaying a television or Internet feed and the off-shore odds.

A server system 11 (also referred to as a television studio 11) is used to create and aggregate data and programming for transmission to the display system 19. Such data and programming includes one or more standard and enhanced fantasy sports games and one or more standard and enhanced betting contests, sports prognosticator predictions and one or more real-time live odds derived from the off-shore sports books 25. The odds from the one or more off-shore sports books 25 and the one or more sports prognosticator predictions are used for general information purposes, such as for setting up strategy, selecting sports teams, and for all fantasy betting sports games.

Standard and enhanced fantasy sports games are games wherein users create fantasy leagues by selecting players from all teams in a selected sport and combining them via drafts, and player trades, for example, to make up the users' fantasy team. Each team plays against other users' teams within a fantasy league or club. Points are awarded based on real performances of individual players for a combined total score. Scores are tracked for every game and teams are ranked against each other within a league.

Enhanced games have additional elements above and beyond those of standard games. For example, such elements might include, but are not limited to, allowing fantasy bets inside the fantasy sports games, on the events (as defined below and certain additional elements) and the results of the games. For example, another enhanced element ties fantasy sports games to separate fantasy betting sports games, which only the player of the original fantasy sports game can play and wherein he/she bets on the outcome of his/her fantasy sports games and the events (as defined below and certain additional elements) related to the sports figures on his/her team or teams. Enhanced games have never been available to players on television.

Standard and enhanced fantasy betting sports games are interactive simulated betting contests. Enhanced fantasy betting contests are those in which players use the real-time off-shore betting odds on real games along with other information, including sports prognosticator predictions, displayed by the system 10 to make fantasy bets on the end results of the real games and on “events” using fantasy cash. Examples of events include, but are not limited to, rushing, passing, field goals, quarterback sacks, number of 3 point baskets, number of home runs, number of saves on goal, rookie of the year, for example. Players either join public leagues, set up private leagues to play against each other or play one-on-one against each other. Players are given virtual cash (fantasy cash), on a weekly basis, for example, which they use to make bets, based on the off-shore odds from whatever off-shore book they choose, and the other information they are given. If a player wins, points are awarded. If the player loses he or she gets nothing. None of these fantasy betting sports games has ever been available to a player on television.

The system 10 may also transmit fantasy betting sports games that use off-shore odds. These fantasy betting sports games allow bets on such things as the events in the previous paragraph, but are not limited to only these events, and may include who will be rookie of the year, who will be traded, which coaches will quit or be fired, game stats on individual players in each game they play, and the like. Thus, these fantasy sports games are games where bets are made on selected events relating to members of fantasy teams, but are unrelated to which real world teams actually win the games. They are available to all players. This type of fantasy betting sports game has not heretofore been available to fantasy sports players and fantasy sports bettors on television.

The system 10 may also transmit fantasy betting sports games that are based on enhanced fantasy sports games. These fantasy betting sports games allow bets on such things as the events in the previous paragraph, but are not limited to only these events, and may include who will be rookie of the year, who will be traded, which coaches will quit or be fired, game stats on individual players in each game they play, the result of a fantasy sports player's own game and the like. Thus, these fantasy sports games are games where bets are made on selected events relating to members of fantasy teams, but are unrelated to whether the real world teams actually win the real world games. They are available only to the fantasy players who are playing certain fantasy sports games. These fantasy betting sports games may either be embedded inside the fantasy sports game to which they apply or be separate fantasy betting sports games tied to those fantasy sports games. This type of fantasy betting sports game has not heretofore been available to fantasy sports players on television.

System 10 may also transmit sports prognosticator predictions using offshore odds.

Interactive commercial transactions (commerce) include situations in which a user, sitting at home for example, can purchase merchandise from an interactive screen by the click of a button or other device.

The server system 11, or studio 11, comprises a central database 12 that receives the real-time live odds from the off-shore sports books 25 and additional sports-related and fantasy sports-related information from sports and fantasy sports information databases 13. The server system 11 comprises a game server 14 that is coupled to the central database 12. The server system 11 also comprises a broadband media server 15 that is coupled to the game server 14.

The broadband media server 15 is a computer system that is capable of transmitting (1) interactive digital video programming, along with the fantasy sports games, the real-time live odds, sports prognosticator predictions and ads or interactive commercial products that are part of interactive commercial transactions, or (2) the interactive digital video programming, alone, from the server system 11 or studio 11 for distribution to the end user display system 19. The game server 14 is a computer system that is capable of transmitting (1) the fantasy sports games and real-time live odds to the broadband media server 15, or (2) the fantasy sports games and real-time live odds by way of the Internet 18, for distribution to the end user display system 19.

The server system 11 is coupled to the end user display system 19 by way of one or more communication links 20. The communication links 20 take a variety of forms, depending upon the type of programming that is distributed and the type of end user display system 19. Exemplary communication links 20 are provided by cable and satellite system providers 17 or operators 17. Other communication links 20 are provided by way of the Internet 18.

The broadcast signal for the channel 10 may be transmitted from any satellite uplink facility coupled to the broadband media server 15. A satellite uplink facility such as the British Telecom transmission facility in the Los Angeles, Calif. area, for example, may be used as the uplink facility. The signal is uplinked to a satellite transponder, which beams it to headend equipment of cable and satellite systems 17 throughout the United States.

For example, digital linear video programming (television broadcast or channel) 16a may be distributed by the cable and satellite system operators 17. Digital interactive video programming (interactive television (iTV) channel) 16b may also be distributed by the cable and satellite system operators 17. An Internet protocol television (IP-TV) channel 16c may be distributed by way of the Internet 18. Interactive video programming may be distributed by way of a website 16d (TheScorelineChannel.com) over the Internet 18.

In the case of the linear video programming only the live off-shore odds and video programming are transmitted to the television system 19. The interactive components, include, but are not limited to, standard and enhanced fantasy betting sports games, standard and enhanced fantasy sports games, sports prognosticator predictions, interactive commerce (e-commerce) and enriched video content transmitted via the Internet 18. In the interactive television programming, the standard and enhanced fantasy sports games and standard and enhanced fantasy betting sports games, sports prognosticator predictions, interactive commerce and real-time live odds are transmitted from the game server 14 by way of the broadband media server 15 to the cable and satellite system operators 17 to the end user display system 19.

In the case of the Internet protocol television programming, interactive video programming is distributed by way of the broadband media server 15 and the Internet 18 to the end user display system 19 and the standard and enhanced fantasy sports games and standard and enhanced fantasy betting sports games, sports prognosticator predictions, interactive commerce and real-time live odds are transmitted from the game server 14 by way of the broadband media server 15 and the Internet 18 to the end user display system 19.

In the case of the website 16d, interactive video programming is distributed by way of the broadband media server 15 and the Internet 18 to the end user display system 19 and the standard and enhanced fantasy sports games and standard and enhanced fantasy betting sports game, sports prognosticator predictions, and e-commerce are distributed by way of the game server 14 and the Internet 18 to the end user display system 19. The communication link 20 between the server system 11 and the display system 19 located at the consumer or game player site may be any combination land line or wireless links.

As is shown in FIG. 1, various communication links 20 are coupled between the server system and the display system 19 for transmitting the programming, including the real-time live odds and standard and enhanced fantasy sports games and standard and enhanced fantasy betting sports games, and sports prognosticator predictions, to the display system 19. Exemplary communication links 20 include cable and satellite systems 17 that are currently in widespread use for delivery of the programming to regular and interactive television systems. For example, the programming provided by the present invention may be distributed as a digital linear channel on major cable and satellite providers 17 including Dish Network, DirecTV, Time Warner Cable, Comcast Cable, Cox Cable, Cablevision, Adelphia Cable, Charter Cable, Mediacom, Insight or any additional small cable system. In the case where the display system 19 is an Internet protocol television system 19 or a web-enabled computer device 19, such as a personal computer, the communication link 20 is provided over the Internet 18 using Internet service providers, which include most of the above-identified cable and satellite providers 17. In addition, a number of major telephone companies, such as SBC, Verizon, BellSouth and Qwest, to name a few, have DSL lines into homes for Internet connectivity that permits television channel distribution.

The Internet protocol television (IP-TV) channel 16b may be implemented using a platform implemented by Microsoft Corporation known as Microsoft® TV. Details of this platform are available on the Microsoft® website. Available descriptive literature include a Microsoft TV fact sheet, Microsoft TV Foundation Edition, and Microsoft TV IPTV Edition Datasheet, for example. Information regarding the Microsoft TV platform may be obtained from reading these documents. In general, the Microsoft TV platform includes systems and services that provide for digital video recording (DVR), on-demand programming, high-definition television (HDTV), and program guide listings using a single customizable menu. The television channel 10 may be delivered to end users using the Microsoft TV platform.

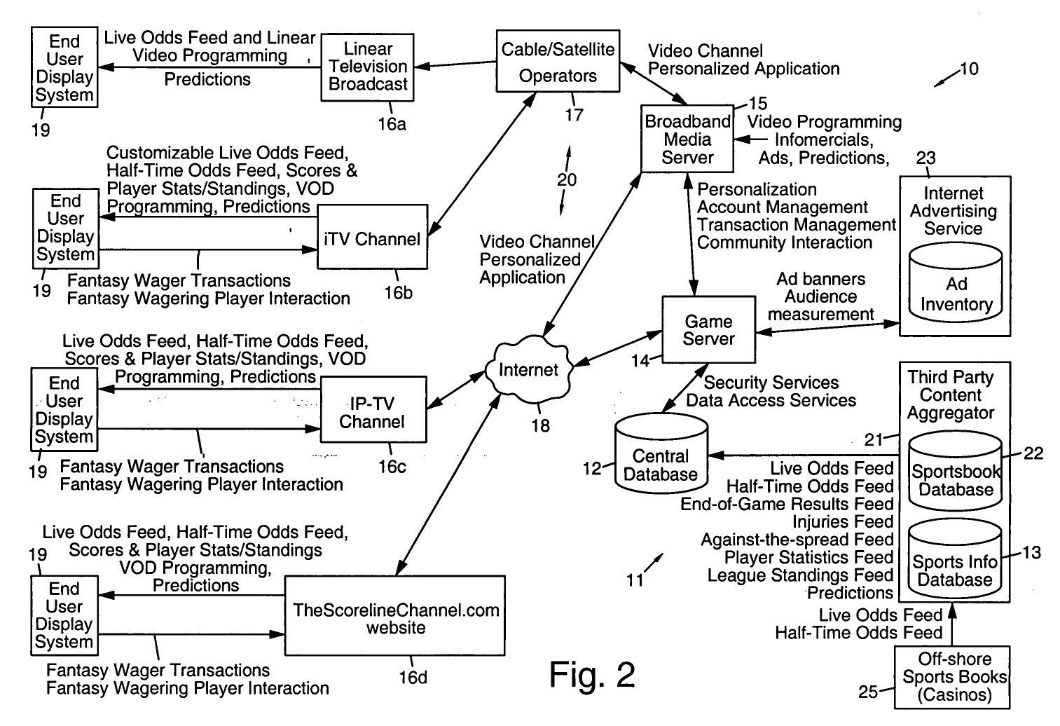

FIG. 2 illustrates additional details regarding the systems 10 shown in FIG. 1. As is shown in FIG. 2, the television broadcasting studio 11 includes a number of databases, including the central database 12, databases that are compiled by a third party content aggregator 21 including the sports information database 13 and a sports book database 22, an advertising database 23 and a sports prognosticator database. The sports book database 22 stores the real-time off-shore odds received from various off-shore odds makers. The sports information database 13 stores information relating to standard and enhanced fantasy sports games that are broadcast, including end-of-game results, injuries, against-the-spread information, player statistics and league standings, for example. The advertising database stores advertising material that is to be broadcast. The sports prognosticator database stores sports prognosticator predictions. The central database combines and organizes the information from the databases compiled by the third party content aggregator 21 and stores the live odds, half-time odds, end-of-game results, injuries, against-the-spread information, player statistics and the league standing derived from the third party content aggregator databases.

The game server 14 outputs fantasy betting sports games and standard and enhanced fantasy sports games and sports prognosticator predictions for broadcast to end user display systems 19 along with the data stored in the central database relating to the standard and enhanced fantasy betting sports game or standard and enhanced fantasy sports game that is broadcast. The game server 14 packages the sports prognosticator predictions, standard and enhanced fantasy betting sports games, and standard and enhanced fantasy sports games with desired advertising derived from the advertising database 23. The broadband media server transmits the current game, the video programming associated with the game, the various feeds, and the advertising to cable and or satellite operators 17 for distribution over satellite or cable systems to end user display systems 19 using a digital, non-interactive television broadcast 16a, or by way of satellite or cable systems to the end user display systems 19 using the interactive television (iTV) channel 16b. The broadband media server 15 and the game server 14 are also coupled to the Internet 18 (or World Wide Web) for distribution of interactive programming to end user display systems 19 by way of an Internet protocol television (IP-TV) channel 16c or the website 16d.

The digital, non-interactive television broadcast 16a or channel 16a delivers live odds and linear video programming to the end user display systems 19. The interactive television (iTV) channel 16b delivers live odds whose order is customizable by preference, half-time odds, scores, player statistics and standings, sports prognosticator predictions and video-on-demand programming to the end user display systems 19. The IP-TV channel 16c delivers live odds, half-time odds, scores, player statistics and standings, fantasy sports games and fantasy betting sports games, sports prognosticator predictions and video-on-demand programming to the end user display systems 19. The website 16d delivers live odds, half-time odds, scores, player statistics and standings, fantasy sports games and fantasy betting sports games, sports prognosticator predictions and video-on-demand programming to the end user display systems 19. The website 16d has fantasy games and sports prognosticator predictions on it, even those that are associated with non-interactive linear digital channels, which may be delivered to the end user display systems 19. The IP-TV channel 16c is interactive, and may also deliver fantasy games and sports prognosticator predictions to the end user display systems 19.

Half-time odds, end-of-game results, injury reports, against-the-spread reports, player statistics and league standings may be included in the programming broadcast via any of the broadcast media (channels 16a-16d). Also, advertising material, infomercials, live game scores, player trade information, club negotiation information, interviews, and other relevant information discussed in the previous paragraph may be aggregated for transmission by the server system 11.

Furthermore, the programming that is presented on an end user display screen 19 may include an “SLC Average” line, which is an indexed average of all offshore betting lines used in the present invention. The SLC Average correlates directly to enhanced fantasy betting sports games that are played. A halftime odds line may be displayed for all sports when available from the off-shore odds makers 25, which increases fantasy wagering capabilities and more detailed information to sports fans, fantasy game players and simulated betting league contestants. Depending upon the particular feed that is provided by the system 10, a player has the ability to choose his or her odds in order of priority, and the display screen 19 displays a selectable button that takes the player to a screen that displays standard and enhanced fantasy wagering features and standard and enhanced fantasy sports gaming features of all the fantasy sports games and fantasy betting contests.

Sports news features directly related to the playing of standard and enhanced fantasy betting sports games and standard and enhanced fantasy sports games may be displayed, including: live game scores, special odds, player trades and club negotiations. A streaming Chiron (called “Fantastat™”) may be, and is preferably, displayed at the bottom of the screen, where detailed fantasy sports statistics are displayed on a 24 hour basis, including player statistics, injury reports and team updates, for example.

Fantastat™ is a section or window of a display screen dedicated to individual player standings and rankings for purposes of standard and enhanced fantasy league games. Data is streamed into the window, on a 24 hour basis, such as by using a service available from Rotowire or Associated Press, for example. Both standard and enhanced fantasy leagues allow users to utilize players from all teams in a selected sport and combine them via drafts, player trades, and the like, to make up a user's fantasy team to compete against other players teams within a fantasy league or club. Points are awarded based on the individual performances of players, and the combined point total of the players on the user's team are tracked on a game-by-game basis and the user is rewarded or ranked within a league based on this combined point total. Enhanced games have additional elements above and beyond those of standard games. For example, such elements might include, but are not limited to, allowing fantasy bets inside the fantasy sports games, on the events (as defined above and certain additional elements) and the results of those games. For example, another enhanced element might be tying fantasy sports games to separate fantasy betting sports games, which only the player of the original fantasy sports game can play and wherein he/she bets on the outcome of his/her fantasy sports games and the events (as defined above and certain additional elements) related to the sports figures on his/her team or teams. The present invention is the first known fantasy sports television channel 11 that provides this player-related information to users during the entire 24 hour period.

Advertising information or relevant programming pertaining to major sports may be displayed in one or more separate windows within the display screen 19. Also, advertisers and sponsors can place ads and sponsorship logos on the display screen 19.

For example, an infomercial discussion relating to odds for a specific recent game or games from real or fantasy sports prognosticator predictions, tips for standard and enhanced fantasy sports gamers who want to avoid standard errors and increase their skill at playing, and betting discussions for standard and enhanced fantasy league bettors may be displayed. Information relating to sports prognosticators, including the accuracy of their predictions and the cost of their services, or league experts, may be displayed. Relevant discussions, live interviews with sports figures, celebrity picks, fantasy sports trivia for the avid sports fan, and sports comedy may also be displayed.

Information about sports prognosticators may be displayed on a display screen 19 in the form of an ad, infomercial, link, phone number or other means of communication. If a player chooses to use the information from the sports prognosticator he/she goes through several steps using a communication link: establish payment, either then or through a previous subscription or account, and request a prediction. The prediction is transmitted via the communication link 20 to the player. Communication links 20 may include, but are not limited to: an interactive television system 19, an IP-TV system 19, a website 16a, an email address, a wireless system 19, a wired system 19 and a telephone.

The system 10, using a digital interactive television system 19 or a non-interactive television system 19 coupled with an interactive website 16a is specifically designed to allow participation in fantasy betting contests and fantasy sports games and the acquisition of sports prognosticator predictions. Exemplary fantasy games, (standard and enhanced fantasy sports games and standard and enhanced fantasy betting contests) developed for the system 10 include, but are not limited to:

(1) Sportsbook 2005, which is free and offers no prizes. This is a fantasy league betting contest. Players either join public leagues or set up private leagues to play against each other. Players are given virtual cash, on a weekly basis, which they use to make bets, based on the off-shore odds from whatever off-shore book they choose. If a player wins, points are awarded. If the player loses he or she gets nothing.

(2) Standard fantasy league sports games have a subscription fee, and offer prizes. Fantasy leagues are both public and private and allow users to utilize players from all teams in a selected sport and combine them via drafts, player trades, and the like, to make up a user's fantasy team to compete against other players' teams within a fantasy league or club. Points are awarded based on the individual performances of players. The combined point total of the players on the user's team are tracked on a game-by-game basis and the user is rewarded or ranked within a league based on this combined point total.

(3) Enhanced fantasy sports games include all this and have certain additional elements. For example, such elements might include, but are not limited to, allowing fantasy bets inside the fantasy sports games, on the events (as defined above and certain additional elements) and the results of those games. For example, another enhanced element may tie fantasy sports games to separate fantasy betting sports games, which only the player of the original fantasy sports game can play and wherein he/she bets on the outcome of his/her fantasy sports games and the events (as defined above and certain additional elements) related to the sports figures on his/her team or teams.

Thus, the system 10 provides for a television channel 10 that permits interactive betting on simulated standard and enhanced fantasy betting sports games and standard and enhanced fantasy sports games that display off-shore betting odds on a display screen of a television or computer device 19. The system 10 provides for a television channel 10 that implements a combination of off-shore odds, standard and enhanced fantasy betting sports games, standard and enhanced fantasy sports games, sports prognosticator predictions and interactive commerce displayed on television and computer devices 19 using interactive TV, IP-TV and non-interactive TV in combination with the website 16a.

The system 10 provides immediate access to live off-shore odds and other sports and fantasy sports related statistics for the most popular sports like professional and college football and basketball, hockey, major league baseball, golf, NASCAR, arena football, boxing, soccer, rugby, cricket, tennis, auto racing and grand prix, 24 hours a day, whenever sports fans and fantasy players want them. No television channel in the market does or has ever done this.

In addition, the system 10 provides access to fantasy casino games including poker, solitaire, blackjack, bridge, canasta, cribbage, deuces wild, double down, euchre, gin, hearts, spades, backgammon, chess, checkers, mahjong, bingo. No television programming service or channel in the market does or has ever done this.

The operational setup required for the system 10 is relatively simple compared to conventional cable channels. The only current original production involves presenting hostesses, referred to as Fantasy Foxes, and creating infomercials for real and fantasy game sports prognosticators and league experts. All other programming may be pre-recorded or licensed. The remainder of the content for the channel 10, including games, are created using computers, and are transmitted via cable and satellite systems to end users, or are available to end users via the website 16d.

Other than original programming relating to the hostesses, the sports prognosticators and the experts, only limited content is provided including: advertising, live off-shore odds, sports scores, player statistics and pre-recorded programming. Because much of the material distributed over the channel 10 is created using computers, this is a highly cost-efficient approach. In addition, advertising content also is provided by way of computer feeds.

Data from the live odds feeds is fed directly to end user display systems 19 to ensure the instantaneous updating of scores and odds. All changes are also compared by human “checkers” of the live feeds to ensure accuracy of information, and to correct any errors or inconsistencies in real time.

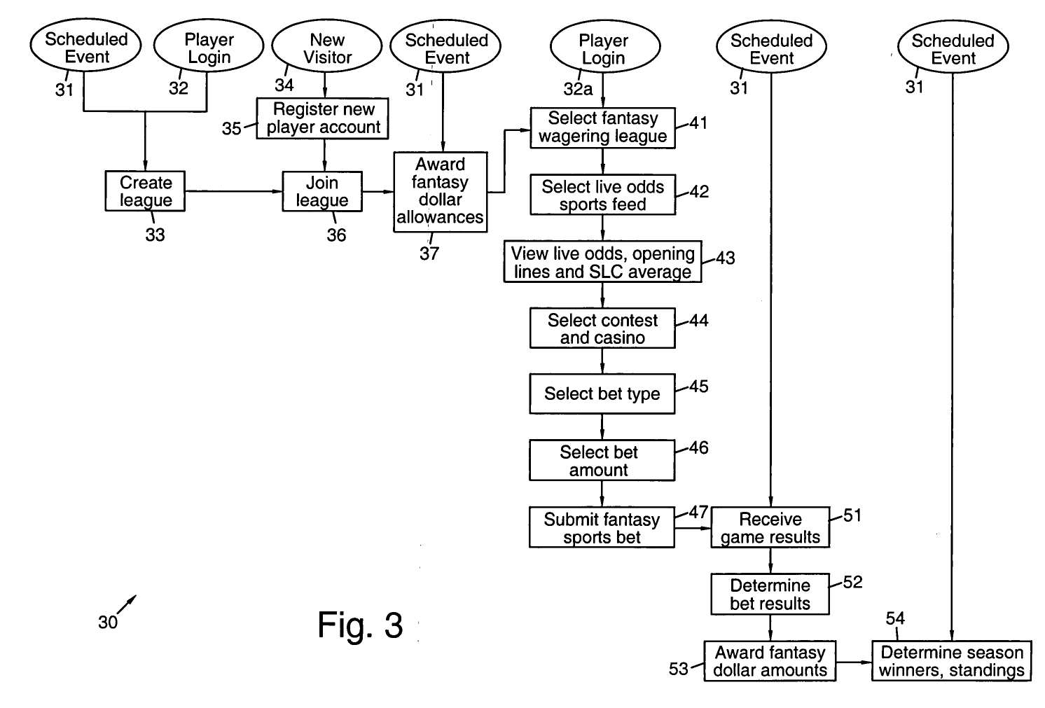

FIG. 3 illustrates an exemplary fantasy wagering process 30 flow diagram. In the exemplary fantasy wagering process 30, an event is scheduled 31 and existing players log in 32 in order to participate in the event. Once a player logs in, a league is created 33. If a new visitor wants to participate in the event, he or she registers to create a new player account and the new player (visitor 34) joins 36 the league. For the scheduled event 31, fantasy dollar allowances are awarded for each of the league members.

At the time the scheduled event is played, a player logs in 32a, selects 41 the appropriate fantasy wagering league, selects a live odds sports feed from those that are available, views 43 the live odds, opening lines and SLC Average line. The player then selects 44 a contest and sports book (casino) or SLC Average that has the odds that he or she desires. The player selects a bet type 45 and a selects a bet amount 46. The selected amount of the fantasy sports bet is submitted 47.

The scheduled event 31 (fantasy betting sports game) is played and the player receives 51 the game results. The bet results are determined indicating the amount of fantasy dollars that the player has won or lost. The fantasy award amounts are then awarded 53 (i.e., added or subtracted from the players fantasy dollar allowance). After the scheduled event (fantasy betting sports game) is finished, league standings are determined 54. At the end of a pre-set period of time season winners are disclosed.

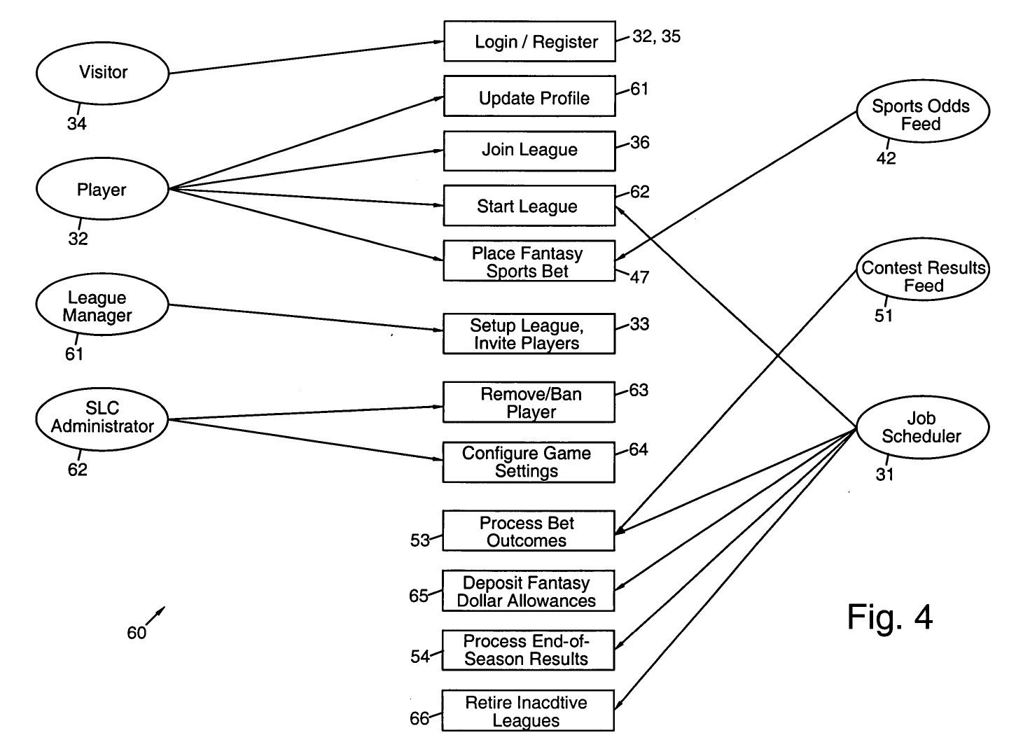

FIG. 4 illustrates an exemplary fantasy use case model. A visitor 34 logs in 32 and registers 35 an existing player 32 logs in and updates his or her profile 61. The player 32 joins 36 a league. The league is started 62 and the player 32 places his or her fantasy sports bet. The league is started by the job scheduler 31.

A league manager 61 is responsible for setting up 33 the league and inviting 33 players to participate in the scheduled fantasy sports game. A league administrator 62 is responsible for removing 63 or banning 63 any player 32 who disregards league rules. The league administrator 62 configures 64 game settings. The job scheduler 31 processes 53 bet outcomes, deposits 65 fantasy dollar allowances, processes 54 end-of-season results, and retires 66 inactive leagues.

The system 10 implements a format of league play relating to fantasy betting sports games that is familiar to fantasy sports players. In most wagering contest sites, garners simply play one-offs against the entire population of the site. The system 10 permits interactive competition between many players.

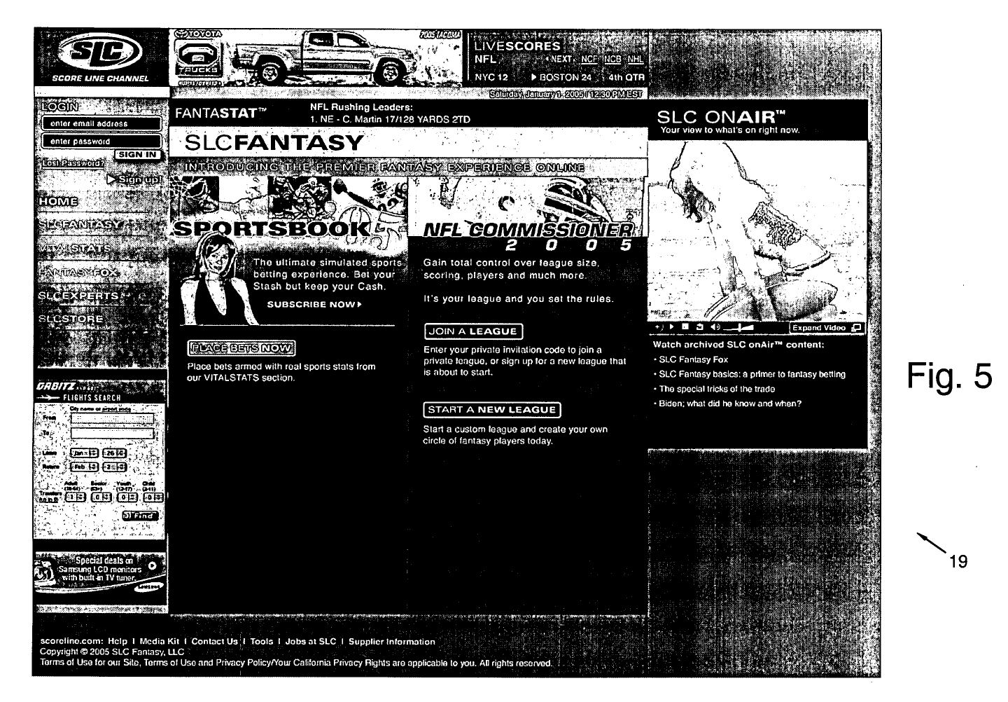

FIGS. 5-10 illustrates exemplary screen displays that are presented on the end user display systems 19, such as the television screens or web-enabled computer devices 19. FIG. 5 is an exemplary screen display of a computer device presented to a user when initially viewing the channel. In FIG. 5, there is advertising and live scores displayed at the upper middle portion of the display screen 19 and on the lower left portion of the display screen 19. The advertising includes links to the advertisers websites and allows shopping via t-commerce directly marketed to a highly targeted demographic audience. Selection buttons (“PLACE BETS NOW”, “JOIN A LEAGUE” and “START A NEW LEAGUE”) are displayed in the middle of the display screen 19, allowing visitors to take appropriate steps to participate in fantasy sports games. The right portion of the display screen shows an on-air hostess along with selection buttons below the image that allows visitors to review archived content.

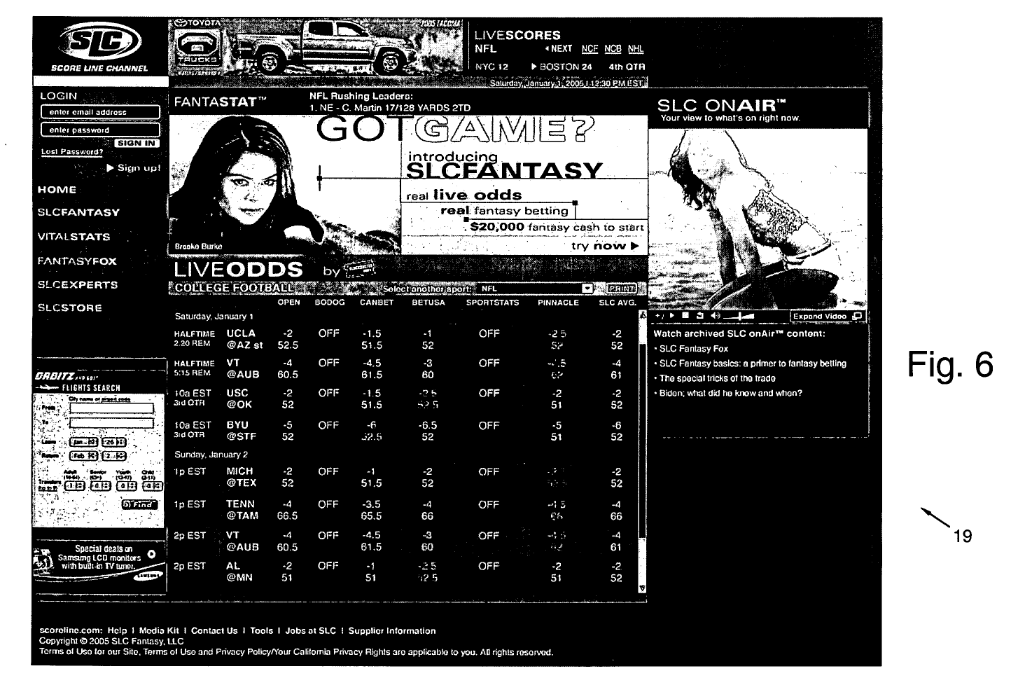

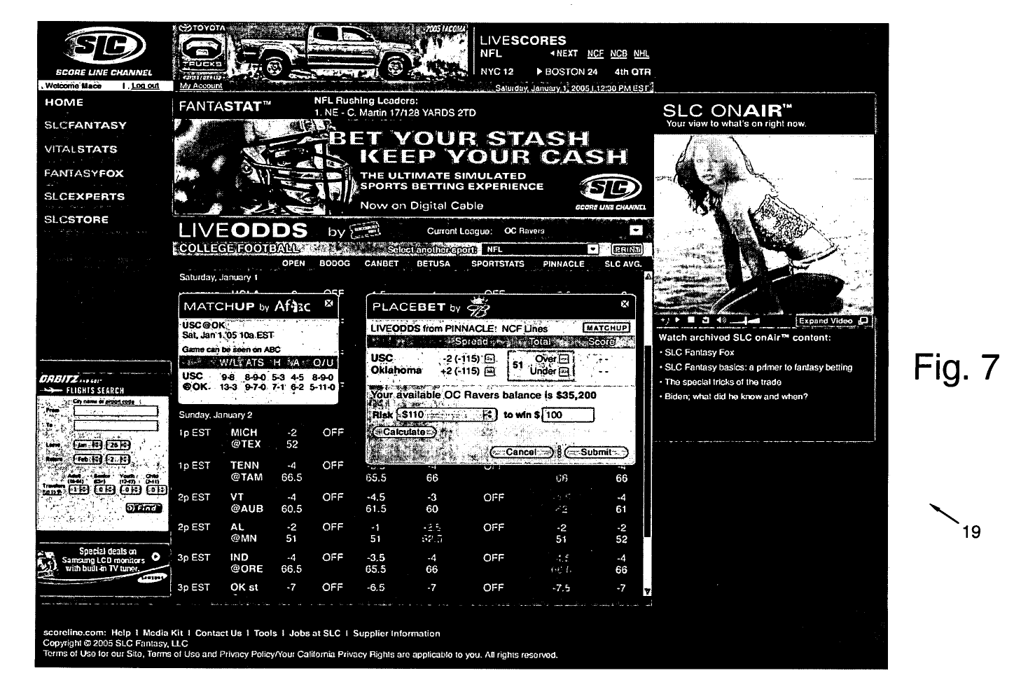

FIG. 6 is an exemplary screen display of a computer device presented to a player 32 that is not logged in. In FIG. 7, the display screen shown in FIG. 6 is overlaid with a live odds display once the player 32 logs in. The live odds screen includes odds posted by date and time, the teams that are competing, opening odds for the games, odds from each of the off-shore odds makers 25 or sports books 25, and the SLC Average.

FIG. 7 is an exemplary screen display of a computer device presented to a player 32 that is logged in. In FIG. 7, the display screen shown in FIG. 6 is overlaid with a match-up screen showing a game that was selected by a player 32 on which to bet. The teams are displayed along with the spread. The amount of the player's fantasy dollar account is displayed. A place bet screen is displayed containing a scroll-down menu that allows the player to select a bet amount and compute a return based upon the odds. Selection buttons are provided to select the bet amount that was entered or cancel the bet.

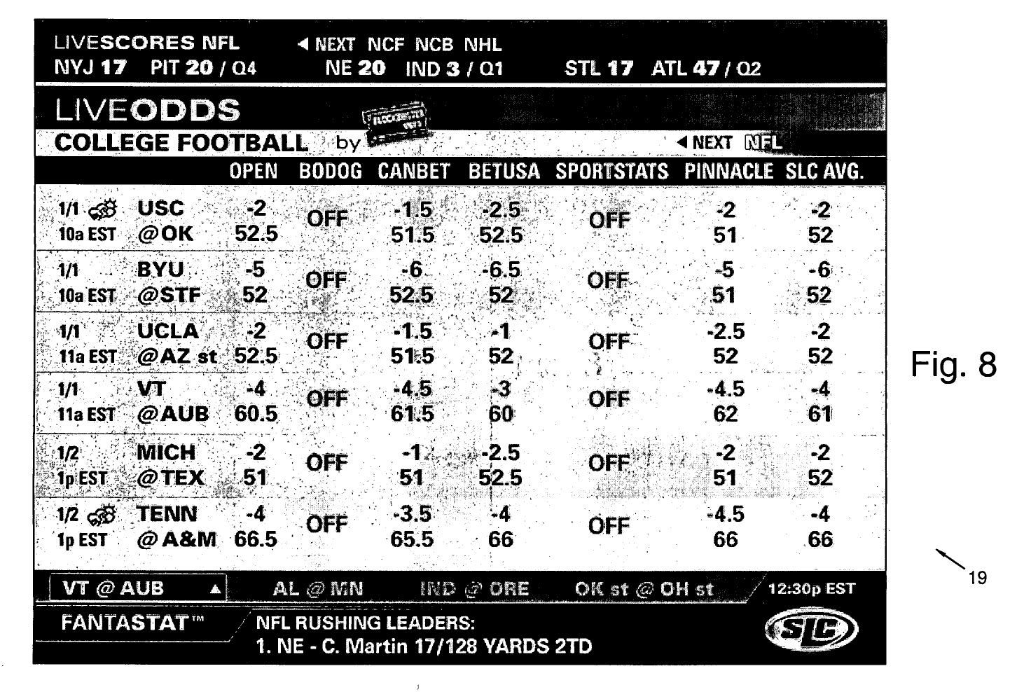

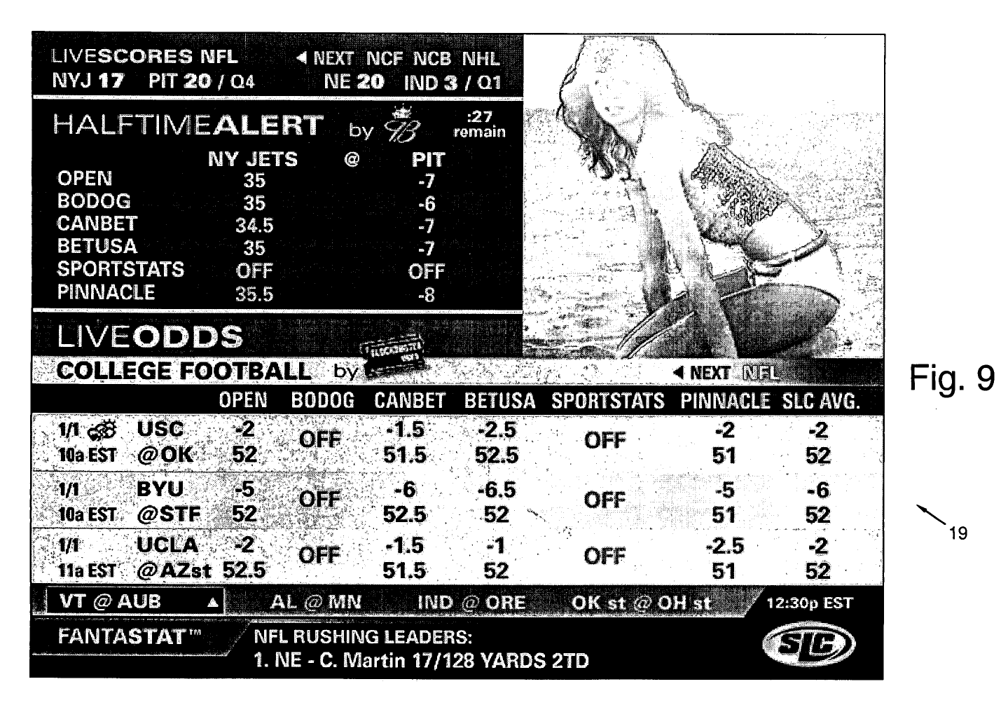

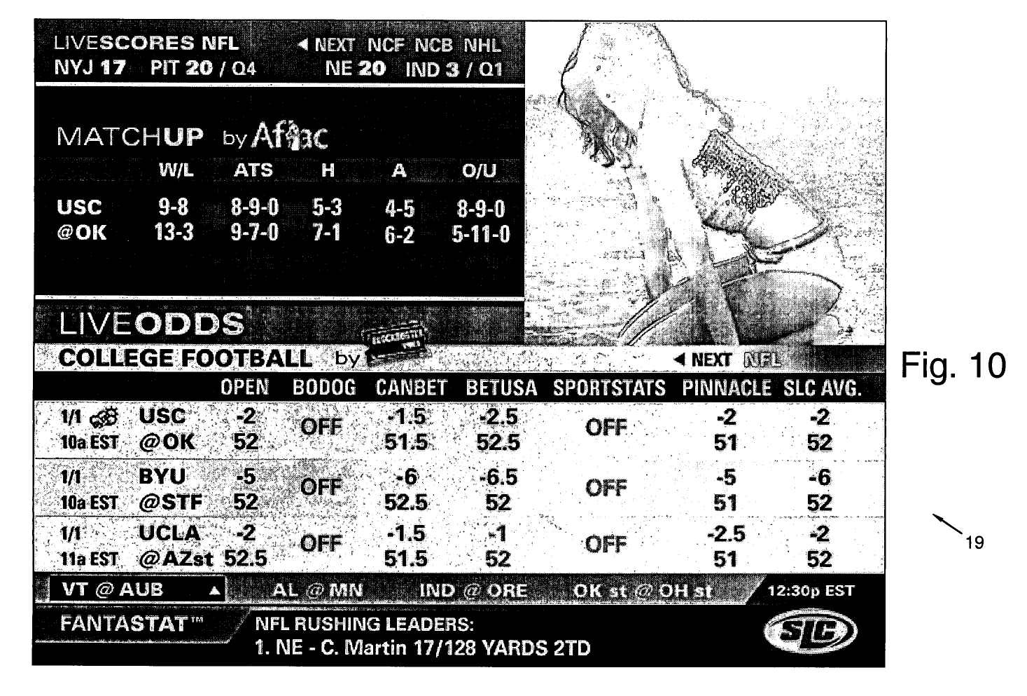

FIG. 8 is an exemplary screen display showing complete live odds for all games on which bets can be placed. FIG. 9 is an exemplary screen display showing half-time odds for selected games. FIG. 10 is an exemplary screen display showing match-up statistics and live odds for the games shown in FIG. 9.

One advantage of the present system 10 is that play in all leagues is made available on the end user display systems 19 in systems 10 where interactivity is possible, and through the website 16d both where interactivity is possible and where interactivity is not possible. This allows players tremendous flexibility, so, that when they are at work, for example, without an interactive television screen, and something important comes up relating to their games, they will have the ability to manipulate their games or modify their strategy as necessary, and those changes will be reflected on their display system 19 when they go home.

The website 16d is provided in addition to the television channels 16a-16c. The website 16d presents content that is substantially similar to the content on the television channels 16a-16c in that it displays league driven fantasy betting contests and other fantasy sports games as well as sports prognosticator predictions. A window is provided into which the television content is streamed.

Players are able to play all the fantasy games on the website 16d. Game templates may be obtained via downloadable web-based software, available to the public from a link on the website 16d. The software allows player involvement in public and private fantasy leagues for betting contests and fantasy sports games.

As with the television screens, there is a screen section allocated to real and fantasy sports, sports prognosticators and league experts. This screen section includes information about the sports prognosticators and league experts and may contain articles written by them and transcripts of their shows. If the display system is interactive it will also show the predictions of the sports prognosticators once the player/user has logged in and either paid for the prediction or the system has automatically determined that he has a current subscription which is available for use. If the television display 19 is not interactive the player may get his/her predictions in one of many ways including, but not limited to: the SLC website 16a, an email address, previously designated phone lines, or other interactive wireless or wired devices.

The website 16d may provide links to sites containing products such as sports tickets, sports equipment, sports vacations, sports memorabilia auctions and other products important to sports fans. In addition the site links to chat rooms where league players can converse with each other.

Fantasy betting contests enable players to place fantasy bets on any single sport or any combination of sports. They allow players to enjoy the excitement of picking against real odds makers and competing with their friends and co-workers, without any of the financial risks inherent in real gambling. Teams and players who make the most winning bets in a week, a month, a year, and throughout the entire course of their participation in a league, will be honored and publicly announced. Players use the statistics, information and off-shore odds displayed on the end user display screens 19 and via the website 16c.

The system 10 takes the concept of league play that is familiar to fantasy sports players and combines it with the excitement of simulated betting contests and real-time off-shore odds. In conventional wagering contest sites, gamers play one-offs against the entire population of the site. The present invention permits group play, which allows players to have a unique and comprehensive real-world experience, without the potential for real-world harm.

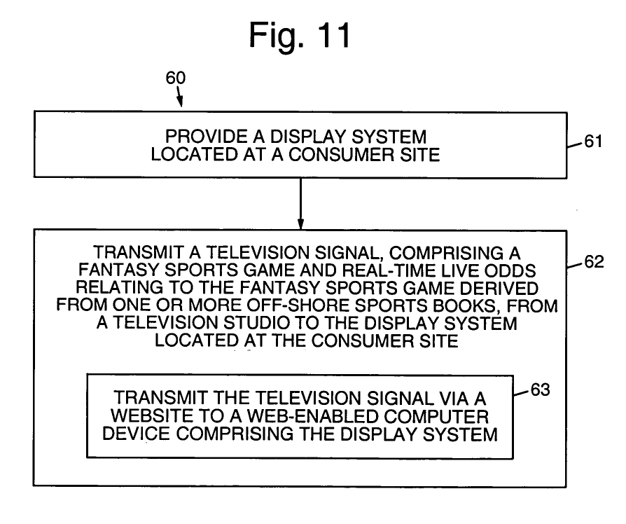

For the purposes of completeness, FIG. 11 is a flow diagram illustrating exemplary embodiments of methods 60 in accordance with the principles of the present invention. Exemplary methods 60 are implemented as follows.

A display system 19 is provided 61 that is located at a consumer site. The display system 19 may comprise a television system, an interactive television system, or a web-enabled computer device. A television signal comprising a fantasy sports game and real-time live odds relating to the fantasy sports game derived from one or more off-shore sports books and sports prognosticator predictions, using offshore odds and relating to the fantasy sports games and fantasy betting sports games, is transmitted 62 from a television studio 11 to the display system 19 located at the consumer site. The television studio 11 may comprise a website 16d and the display system 19 may comprise a web-enabled computer device 19 that displays the fantasy sports game, and sports prognosticator predictions and real-time live odds when the web-enabled computer device 19 is linked to the website 16d.

Thus, systems and methods for delivering real-time off-shore odds, sports prognosticator predictions and interactive fantasy sports games and fantasy betting contests to consumers have been disclosed. It is to be understood that the above-described embodiments are merely illustrative of some of the many specific embodiments that represent applications of the principles of the present invention. Clearly, numerous and other arrangements can be readily devised by those skilled in the art without departing from the scope of the invention.

What is claimed is:

1. A fantasy television system, comprising:
a display system located at a consumer site;
a server system for transmitting odds derived from one or more off-shore sports books for purposes of information and playing fantasy games to the display system located at the consumer site; and
a communication link coupled between the server system and the display system for transmitting the real-time live betting odds to the display system.

2. The system recited in claim 1 wherein the display system comprises an interactive display system and wherein the server system transmits one or more fantasy betting sports games to the display system.

3. The system recited in claim 2 wherein the server system transmits one or more standard fantasy sports games to the display system.

4. The system recited in claim 1 wherein the server system transmits one or more predictions of sports prognosticators to the display screen, for information purposes, and for playing fantasy games.

5. The system recited in claim 4 wherein the server system transmits one or more predictions of sports prognosticators using a medium selected from a group including a website, an email address, a wired telephone and a wireless device.

6. The system recited in claim 2 wherein the server system transmits one or more predictions of sports prognosticators to the display screen, for information purposes and playing fantasy games.

7. The system recited in claim 2 wherein the server system transmits one or more fantasy casino games to the display system.

8. The system recited in claim 2 wherein the server system transmits one or more fantasy casino betting games related to the fantasy casino games to the display system.

9. The system recited in claim 1 wherein the server system transmits one or more standard fantasy sports games to the display system and wherein a player of standard fantasy sports games can place fantasy bets on outcomes of the standard fantasy sports games.

10. The system recited in claim 2 wherein the server system transmits one or more standard fantasy sports games to the display system and wherein a player of the standard fantasy sports games can place fantasy bets on outcomes of the standard fantasy sports games.

11. The system recited in claim 1 wherein the server system transmits one or more fantasy sports games to the display system and wherein a player of the fantasy sports games can place fantasy bets on events and other elements of the fantasy sports games and the performance of the sports figures and people related to them included in the fantasy sports games, as part of the games.

12. The system recited in claim 2 wherein the server system transmits one or more fantasy sports games to the display system and wherein the player of the fantasy sports game can place fantasy bets on events and other elements of the fantasy sports games and performance of the sports figures and other people related to them included in the fantasy sports games, as part of the games.

13. The system recited in claim 1 wherein the server system transmits one or more fantasy sports games to the display system and wherein a player of the fantasy sports games can place fantasy bets on events of the fantasy sports games separate from the games.

14. The system recited in claim 2 wherein the server system transmits one or more fantasy sports games to the display system and wherein a player of the fantasy sports games can place fantasy bets on events of the fantasy sports games, separate from the games.

15. The system recited in claim 3 wherein the one or more fantasy sports games is selected from the group including college and professional football, basketball, baseball, hockey, NASCAR, golf, Arena football, boxing, auto racing, soccer, rugby, cricket, and Grand Prix racing.

16. The system recited in claim 7 wherein the one or more fantasy casino games are selected from a group including poker, solitaire, blackjack, bridge, canasta, cribbage, deuces wild, double down, euchre, gin, hearts, spades, backgammon, chess, checkers, mahjong, bingo.

17. The system recited in claim 8 wherein one or more fantasy betting casino games related to one or more fantasy casino games are selected from a group including poker, solitaire, blackjack, bridge, canasta, cribbage, deuces wild, double down, euchre, gin, hearts, spades, backgammon, chess, checkers, mahjong, bingo.

18. The system recited in claim 2 wherein the server system transmits interactive commercial transactions to the display system.

19. The system recited in claim 1 wherein the display system comprises a television system.

20. The system recited in claim 1 wherein the display system comprises an interactive television system.

21. The system recited in claim 1 wherein the display system comprises a web-enabled computer device.

22. The system recited in claim 1 wherein the display system comprises a wireless device and the communication link is wireless.

23. The system recited in claim 1 wherein the display system comprises a wireless interactive display system and the communication link is wireless.

24. The system recited in claim 1 wherein the communication link is a wired communication link.

25. The system recited in claim 4 where the communication link is a telephone

26. The system recited in claim 1 wherein the server system comprises a website and wherein the display system comprises a web-enabled computer device that displays the one or more fantasy betting sports games, and real-time live betting odds when the web-enabled computer device is linked to the website.

27. The system recited in claim 26 wherein the server system transmits one or more predictions of sports prognosticators to the display screen, for information purposes, and for playing fantasy games.

28. The system recited in claim 1 wherein the server system transmits an average betting statistic comprising an indexed average of all offshore betting odds.

29. The system recited in claim 2 wherein the fantasy betting sports games comprise games where bets are made on selected events and other elements of the performance of the sports figures and people related to them included in the fantasy sports games, as part of the games and are unrelated to teams that win the games.

30. The system recited in claim 1 wherein the server system transmits a streaming Chiron for display by the display system that shows detailed fantasy sports statistics.

31. A method comprising:
providing a display system located at a consumer site; and
transmitting a television signal comprising betting odds derived from one or more off-shore sports books from a television studio to the display system located at the consumer site.

32. The method recited in claim 31 wherein the display system comprises an interactive display system and wherein one or more fantasy betting sports games are transmitted to the display system.

33. The method recited in claim 31 wherein one or more predictions of sports prognosticators is transmitted to the display screen for information purposes and for playing fantasy games.

34. The method recited in claim 31 wherein one or more fantasy sports games are transmitted to the display system.

35. The method recited in claim 31 wherein one or more fantasy casino games are transmitted to the display system.

36. The method recited in claim 31 wherein one or more fantasy betting casino games related to one or more fantasy casino games are transmitted to the display system.

37. The method recited in claim 31 wherein one or more fantasy sports games are transmitted to the display system and wherein a player of the fantasy sports games can place fantasy bets on outcomes of the fantasy sports games.

38. The method recited in claim 31 wherein one or more fantasy sports games are transmitted to the display system and wherein a player of the fantasy sports games can place fantasy bets on outcomes of the fantasy sports games.

39. The method recited in claim 32 wherein the one or more fantasy sports games is selected from the group including college and professional football, basketball, baseball, hockey, NASCAR, golf, Arena football, boxing, auto racing, soccer, rugby, cricket, and Grand Prix racing.

40. The method recited in claim 35 wherein the one or more fantasy casino games are selected from the group including poker, solitaire, blackjack, bridge, canasta, cribbage, deuces wild, double down, euchre, gin, hearts, spades, backgammon, chess, checkers, mahjong, and bingo.

41. The method recited in claim 31 wherein interactive commercial transactions are transmitted to the display system.

42. The method recited in claim 31 wherein the display system comprises a television system.

43. The method recited in claim 31 wherein the display system comprises an interactive television system.

44. The method recited in claim 31 wherein the display system comprises a web-enabled computer device.

45. The method recited in claim 31 wherein the display system comprises a wireless device and the television signal is wirelessly transmitted.

46. The method recited in claim 31 wherein the display system comprises a wireless interactive device and the television signal is wirelessly transmitted.

47. The method recited in claim 31 wherein the television studio comprises a website and wherein the display system comprises a web-enabled computer device that displays the fantasy sports game, fantasy betting sports game and real-time live betting odds when the web-enabled computer device is linked to the website.

48. The method recited in claim 31 wherein the television signal comprises an average betting statistic that is an indexed average of all offshore betting odds.

49. The method recited in claim 31 wherein the television signal comprises a streaming Chiron that shows detailed fantasy sports statistics.

50. The method recited in claim 31 wherein the television signal comprises information provided by sports prognosticators and league experts.

51. The method recited in claim 32 wherein the fantasy betting sports games comprise games where bets are made on selected events and other elements of the performance of the sports figures and other people related to them included in the fantasy sports games, as part of the games and are unrelated to teams that win the games.
